(19) United States
(12) Patent Application Publication
(10) Pub. No.: US 2008/0007648 A1
(43) Pub. Date: Jan. 10, 2008

(54) Real time scaling and rotating decoded image data

(75) Inventors: Xuyun Chen, San Jose, CA (US); Shi Chen, San Jose, CA (US)

Correspondence Address: Howard Chen, Esq.;Preston Gates & Ellis LLP, Suite 1700, 55 Second Street, San Francisco, CA, 94150, US

(73) Assignee: Amlogic, Inc.

(21) Appl. No.: 11/474,136

(22) Filed: Jun. 23, 2006

(51) Int. Cl. H04N 7/01

(52) U.S. Cl. 348/441

(57) ABSTRACT

This invention discloses a block-based streaming image processing system and method for being implemented in an integrated circuit (IC), the system and method comprise at least one scaling module for scaling a decoded streaming image block-by-block to a predetermined aspect ratio, and at least one rotating module for rotating the decoded streaming image block-by-block with a predetermined angle or flipping the decoded streaming image block-by-block on a predetermined direction, wherein the decoded streaming image after being processed by the streaming image processing system is ready for being properly displayed in a predetermined manner.

### BACKGROUND

The present invention relates generally to a system and method for processing digital images, and, more particularly, to real-time scaling and rotating decoded video image data.

When taking a video with a camera or camcorder, the camera can be held at any angle. But when a recorded video is played back in a display device, such as a TV set, the display device can not be rotated to match the camcorder angle. This results in the recorded video being displayed in an angle, which is awkward to viewers. For example, if a video is taken with a camcorder turned clockwise 90 degrees, then the playback of the video is also turned clockwise 90 degrees, a standing person in the video would appear lying down.

A computer can easily rotate a digital image to certain angles. But rotating every image of a video clip of any length one by one on such a computer is not practical for consumer use, and especially, cannot be applied to real-time, streaming video image data. Such a real-time streaming system takes in streaming data, processes them and delivers the processed data also in a stream.

A digital image normally contains a large amount of information and requires many millions of bytes to represent respective pixels of the images with good fidelity. Traditional way of rotating a digital image requires large amount of memory to store the rotated image data, and then output the data to a display device from the memory. In a computer system, this traditional way utilizes computer's system memory. But as aforementioned, the computer rotating system can not be applied to real-time image processing. But if implementing this traditional way in an integrated circuit (IC), large memory size will drastically increase the cost of manufacturing such IC, and render it unfit for consumer use.

As such, what is desired is a method and system for real-time digital image adjustment that can be incorporated in a digital streaming media system.

### SUMMARY

This invention discloses a block-based streaming image processing system and method for being implemented in an integrated circuit (IC), the system and method comprise at least one scaling module for scaling a decoded streaming image block-by-block to a predetermined aspect ratio, and at least one rotating module for rotating the decoded streaming image block-by-block with a predetermined angle or flipping the decoded streaming image block-by-block to a predetermined direction, wherein the decoded streaming image after being processed by the streaming image processing system is ready for being properly displayed in a predetermined manner.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 is a block diagram illustrating a real-time scaling and rotating system according to one embodiment of the present invention.

FIG. 2 illustrates using residue data to extrapolate additional image information.

FIG. 3 illustrates an advantage of block based processing in terms of memory size requirement.

FIG. 4 illustrates a 90 degree clockwise rotation.

FIG. 5 illustrates an exemplary rotating module comprising multiple engines according to one embodiment of the present invention.

FIGS. 6A and 6B are block diagrams showing steps of scaling and rotating a block-based streaming image according to the present invention.

FIGS. 7A and 7B are block diagrams showing steps of just scaling a block-based streaming image according to the present invention.

### DESCRIPTION

The present disclosure provides a real-time digital image scaling and rotating design for being implemented in an integrated circuit (IC) that can be incorporated in a digital streaming media system.

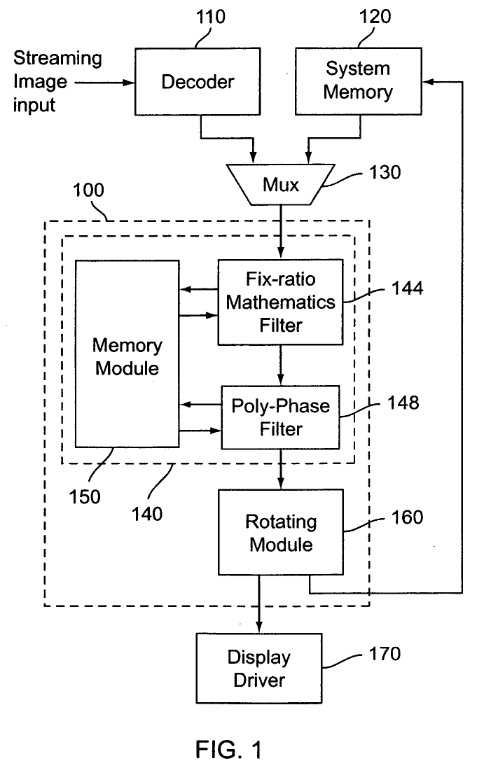

FIG. 1 is a block diagram illustrating a real-time scaling and rotating system 100 according to one embodiment of the present invention. Image data input to the system 100 are decoded streaming data, either directly from a decoder 110 or from a system memory 120. A multiplexer 130 switches between these two data sources, the decoder 110 and the system memory 120.

Digital image data are often encoded or compressed for easy transmission and storage. JPEG point Photographic Experts Group) is a commonly used standard method of lossy compression for photographic images. Motion JPEG (M-JPEG) is an encoding standard where each video field is separately compressed into a JPEG image. During the playback, the compressed images are reversely decoded and form an image stream.

Referring to FIG. 1, the real-time scaling and rotating system 100 according to one embodiment of the present invention contains a scaling module 140 and a rotating module 150. The scaling module 140 further comprises a fix-ratio mathematics filter 144, a poly-phase filter 148 and a memory module 150.

Referring to FIG. 1, the fix-ratio mathematics filter 144 is to shrink the input image in both horizontal and vertical directions proportionally. For instance, if an input image data are an 8×8 pixel block, a shrink of a factor of 4 by the fix-ration mathematics filter will turn the image data into a 2×2 pixel block.

But the input image may not always match a display medium's aspect ratio or the final resolution. For instance, a video taken by an older camcorder may have an aspect ratio of 4:3. Feeding that video to a modern TV set with an aspect ratio of 16:9 may not be able to fill up the whole screen of the TV set in this case, a shrink in just one dimension may be needed to match the image aspect ratio with that of the display medium. The poly-phase filter 148 carries out only one dimensional shrink on a stream of image data. The aspect ratios of both the input image and the display medium determines which dimension and what shrink factor the poly-phase filter 148 are used to process the data. Or when the image is very large (e.g. 16 MegaPixels image) and needs to be scaled to a 1920×1080 screen, the poly-phase filter 148 can perform two-dimensional filtering by performing one dimensional filtering, then storing the temporary data in system memory 120, then perform the second one-dimensional filtering using the poly-phase filter 148 again.

Both the fix-ratio mathematics filter 144 and the poly-phase filter 148 have an access to a small memory module 150. The purpose of the memory module 150 is to temporarily store working copies of the image data being processed, as well as to store residue data.

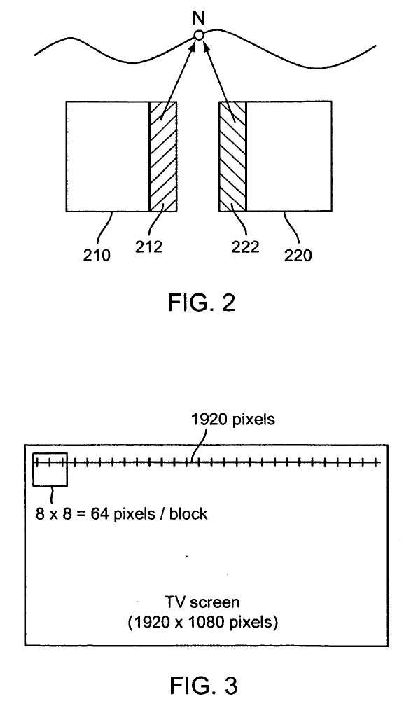

FIG. 2 illustrates using residue data to extrapolate additional image information according to one embodiment of the present invention. As mentioned earlier, the real-time scaling and rotating system 100 processes block data. Sometimes information for a pixel N between two adjacent blocks 210 and 220 need to be extrapolated from the residue data 212 and 222 of the adjacent blocks 210 and 220, respectively. The residue data 212 and 222 are temporarily stored in the memory module 150.

FIG. 3 illustrates an advantage of block based processing in term of memory management, assuming a screen of a TV set has 1920 horizontal pixels. For a pixel based processing module, the memory module 150 as shown in FIG. 1 will need to be large enough to store working copies of at least 1,920 pixels. For a block based processing module, and assuming the block size is 8×8 pixels, then the working copies are only 64 pixels. This significantly reduces the requirement of the memory size in a chip, thereby reducing the chip's cost.

Referring back to FIG. 1, beside the scaling module 140, an image rotating module 160 is added according to one embodiment of the present invention, so that the system 100 can rotate the streaming image in real-time as well. Data coming out of the rotating module 160 can be either fed directly to a display driver 170 or sent to the memory 120 for further processing by the system 100. The processing speed of a hardware system like system 100 is much faster than image displaying speed, so a block of image data can be processed multiple times before being displayed. On the other hand, not all the images need to be scaled or rotated, for those images not needing such processing, scaling module 140 or rotating module 160 can be skipped. Besides, a sequence of the processing, scaling and rotating, is also arbitrary. The rotating does not have to always follow the scaling, and vice versa.

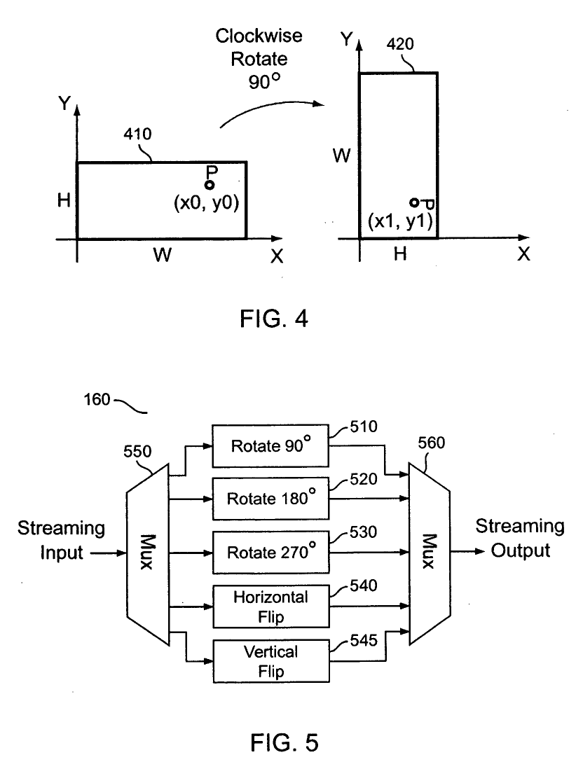

FIG. 4 illustrates a 90 degree clockwise rotation as one example of video data adjustment. A pixel P at (x0, y0) in the original image 410 can be simply mapped to (x1, y1) in the rotated image 420. Assuming the width and height of the original image 410 are W and H, respectively, then

x1=y0, and y1=W−x0.

### Similarly, if the rotation is 180 degrees, then

x1=W−x0, and y1=H−y0.

### If the rotation is 270 degrees, then

x1=H−y0, and y1=x0.

### In case of a horizontal flip,

x1=W−x0, and y1=y0.

Aforementioned simple arithmetic operations are implemented by integrated circuits (ICs) according to one embodiment of the present invention.

FIG. 5 illustrates an exemplary rotating module 160, comprising multiple rotating engines, 90-degree engine 510, 180-degree engine 520, 270-degree engine 530, horizontal flipping engine 540 and vertical flipping engine 545. Multiplexers 550 and 560 pick an engine to process and output the streaming image data.

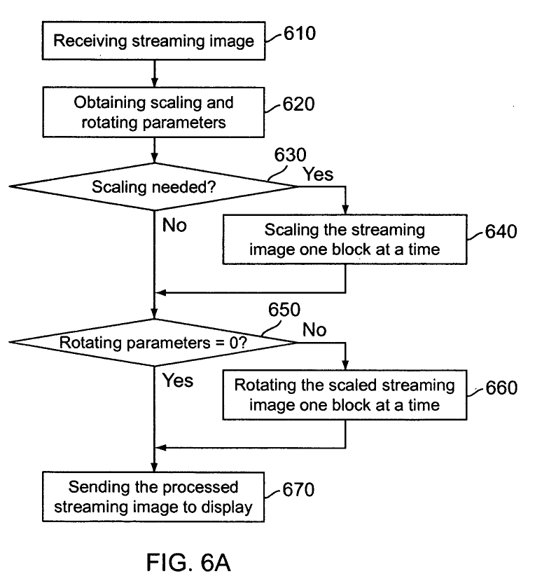

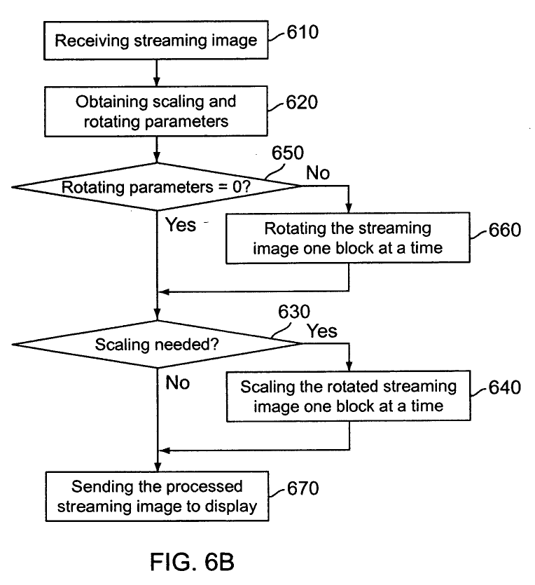

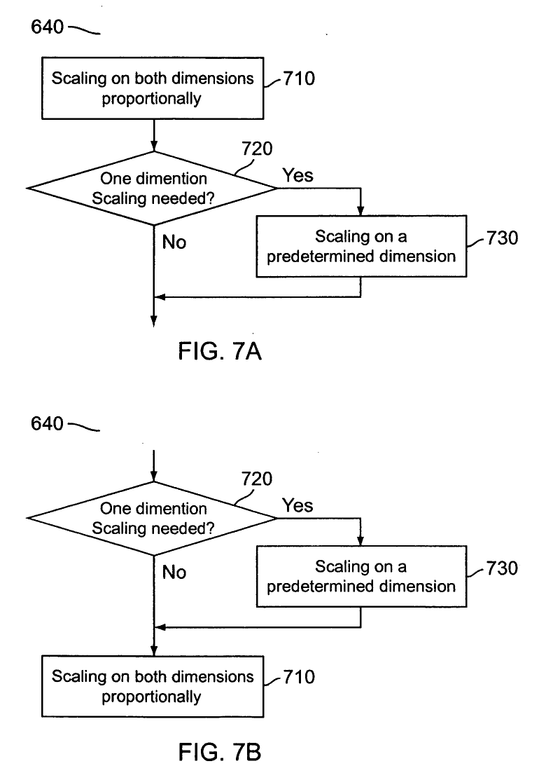

FIGS. 6A and 6B are block diagrams showing steps of scaling and rotating a block-based streaming image, and FIGS. 7A and 7B show steps of just scaling subset of the scaling and rotating operation according to embodiments of the present invention.

Referring to FIG. 6A, the scaling and rotating system 100 as shown in FIG. 1, first receives blocked-based streaming image in step 610. Then the system 100 obtains scaling and rotating parameters from settings provided by either an operator or system itself in step 620. These parameters can be changed from time to time. In step 630, the system 100 detects if the received streaming image matches the aspect ratio of a display device, if not, scaling will be needed. As the streaming image is blocked based, scaling is also carried out on one block at a time in step 640. In step 650, the system 100 detects if the rotating parameter is set at 0 degree or some other angle. If not, the system will rotate the scaled block of the streaming image to a predetermined angle, most commonly 90 degrees, 180 degrees or 270 degrees in step 660. Rotating of step 660 can also include flipping the scaled block. On the other hand, if the rotating parameter is set at 0 degree, then the rotating step 660 will be skipped, and the system 100 will send the processed streaming image to a display or system memory in step 670.

Steps shown in FIG. 6B achieve the same result as the steps shown in FIG. 6A, but a difference is that in FIG. 6B the rotating steps are ahead of the scaling steps while in FIG. 6A, the streaming image is scaled first before run through a predetermined rotation.

FIGS. 7A and 7B shows sub-steps of the scaling steps 640 shown in FIGS. 6A and 6B. Referring to FIG. 7A, a first scaling step 710 is to scale on both dimensions proportionally to match the streaming image with a display resolution. If aspect ratios between the streaming image and the display are not a match which is detected in step 720, then a one dimensional scaling will be carried out in step 730.

Referring to FIG. 7B, the one dimensional scaling step 730 can be carried out ahead of the two dimensional scaling step 710, and still achieve the same result.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A block-based streaming video image processing system comprising:
at least one scaling module for scaling a decoded streaming image block-by-block to a predetermined aspect ratio; and
at least one rotating module for rotating the decoded streaming image block-by-block with a predetermined angle or flipping the decoded streaming image block-by-block in a predetermined direction,
wherein the decoded streaming image, after being processed, is ready for being displayed according to the predetermined aspect ratio.

2. The streaming image processing system of claim 1, wherein the scaling module further comprises:
at least one fix-ratio mathematics filter for shrinking the decoded streaming image block-by-block by a predetermined factor in both horizontal and vertical dimensions proportionally; and
at least one poly-phase filter for shrinking the decoded streaming image block-by-block by a predetermined factor in just one predetermined dimension.

3. The streaming image processing system of claim 2, wherein the scaling module further comprises one or more memory modules for temporarily storing working copies and residue data of a block of the decoded streaming image being processed.

4. The streaming image processing system of claim 3, wherein the one or more memory modules further include at least one memory module for temporarily storing working copies and residue data of a block of the decoded streaming image being processed by the poly-phase filter.

5. The streaming image processing system of claim 4, wherein the one or more memory modules further include at least one memory module for temporarily storing working copies and residue data of a block of the decoded streaming image being processed by the fix-ratio mathematics filter.

6. The streaming image processing system of claim 1, wherein the predetermined angle is 90 degrees, 180 degrees or 270 degrees.

7. The streaming image processing system of claim 1, wherein the predetermined direction is horizontal or vertical.

8. The streaming image processing system of claim 1, wherein the block size is fixed (e.g. 8 pixels by 8 pixels).

9. A method for adjusting a block-based decoded streaming image in real-time for proper display, the method comprising:
receiving the block-based decoded streaming image;
scaling at least one block of the block-based decoded streaming image to match a predetermined aspect ratio based on a display requirement; and
rotating the scaled block by a predetermined angle.

10. The method of claim 9, wherein the block-based decoded streaming image is a video streaming image.

11. The method of claim 9, wherein the scaling further comprises shrinking the block of decoded streaming image by a predetermined factor in both horizontal and vertical dimensions proportionally.

12. The method of claim 9, wherein the scaling further comprises shrinking the block of decoded streaming image by a predetermined factor in just one predetermined dimension.

13. The method of claim 9, wherein the scaling further comprises:
shrinking the block of the decoded streaming image by a predetermined factor in both horizontal and vertical dimensions proportionally to generate a shrunk block of the decoded streaming image; and
shrinking the shrunk block of the decoded streaming image by a predetermined factor in at least one predetermined dimension.

14. The method of claim 9, wherein the scaling further comprises:
shrinking the block of the decoded streaming image by a predetermined factor in just one predetermined dimension to generate a shrunk block of the decoded streaming image; and
shrinking the shrunk block of the decoded streaming image by a predetermined factor in both horizontal and vertical dimensions proportionally.

15. The method of claim 9, wherein the predetermined angle is 90 degrees, 180 degrees and 270 degrees.

16. The method of claim 9, wherein the rotating further comprises flipping the block of decoded streaming image in a predetermined direction.

17. The method of claim 16, wherein the predetermined direction is either horizontal or vertical.

18. A method for adjusting a block-based decoded streaming image in real-time for proper display, the method comprising:
receiving the block-based decoded streaming image;
rotating at least one block of the block-based decoded streaming image by a predetermined angle; and
scaling the rotated block to match a predetermined aspect ratio based on a display requirement.

19. The method of claim 18, wherein the block-based decoded streaming image is a video streaming image.

20. The method of claim 18, wherein the predetermined angle is 90 degrees, 180 degrees and 270 degrees.

21. The method of claim 18, wherein the rotating further comprises flipping the block of decoded streaming image in a predetermined direction.

22. The method of claim 21, wherein the predetermined direction is either horizontal or vertical.

23. The method of claim 18, wherein the scaling further comprises shrinking the rotated block by a predetermined factor in both horizontal and vertical dimensions proportionally.

24. The method of claim 18, wherein the scaling further comprises shrinking the rotated block by a predetermined factor in just one predetermined dimension.

25. The method of claim 18, wherein the scaling further comprises:
shrinking the rotated block by a predetermined factor in both horizontal and vertical dimensions proportionally to generate a shrunk block; and
shrinking the shrunk block by a predetermined factor in at least one predetermined dimension.

26. The method of claim 9, wherein the scaling further comprises:
shrinking the rotated block by a predetermined factor in just one predetermined dimension to generate a shrunk block; and
shrinking the shrunk block by a predetermined factor in both horizontal and vertical dimensions proportionally.
